(19) United States
(12) Patent Application Publication
(10) Pub. No.: US 2026/0110932 A1
(43) Pub. Date: Apr. 23, 2026

(54) POLYMER DISPERSION-TYPE LIQUID CRYSTAL FILM

(71) Applicant: NITTO DENKO CORPORATION, Ibaraki-shi, Osaka (JP)

(72) Inventors: Masanori OTSUKA, Ibaraki-shi, Osaka (JP); Kenta WATANABE, Ibaraki-shi, Osaka (JP); Mariko HIRAI, Ibaraki-shi, Osaka (JP)

(21) Appl. No.: 19/168,464

(22) PCT Filed: Mar. 7, 2024
(86) PCT No.: PCT/JP2024/008798

§ 371 Date: Sep. 24, 2025

(30) Foreign Application Priority Data
Mar. 24, 2023 (JP) 2023-048075

(51) Int. Cl. G02F 1/1334

(52) U.S. Cl. CPC G02F 1/1334; G02F 2202/04

(57) ABSTRACT

An object of the present invention is to provide a polymer dispersed liquid crystal film that can switch a colored state and a transparent state, and has improved transparency in the colored state. A polymer dispersed liquid crystal film of the present invention includes in the following order: a first transparent conductive film; a polymer dispersed liquid crystal layer; and a second transparent conductive film. The polymer dispersed liquid crystal layer contains: a polymer matrix; and droplets dispersed in the polymer matrix, the droplets each containing a liquid crystal component and a dichroic dye. The droplets have an average particle diameter of 1 μm or less. The polymer dispersed liquid crystal film has a clarity in a colored state of 90 or more.

### TECHNICAL FIELD

The present invention relates to a polymer dispersed liquid crystal film.

### BACKGROUND ART

A polymer dispersed liquid crystal (hereinafter sometimes referred to as “PDLC”) film including a PDLC layer containing a polymer matrix and droplets of a liquid crystal component between a pair of transparent electrode layers can change the extent to which transmitted light is scattered in the PDLC layer in accordance with the quantity of a voltage applied to the layer. The PDLC film can switch a state in which the light is scattered (a scattering state) and a state in which the light is transmitted (a transparent state) by, for example, switching a voltage applied state and a voltage non-applied state (Patent Literature 1). The application of the PDLC film to windows, wall surfaces, partitions, and the like of vehicles, such as an automobile and a train, offices, commercial facilities, houses, and the like, as a light-controlling film capable of improving privacy or security through utilization of such function has been advanced.

The PDLC film in which a dichroic dye is incorporated into droplets of a liquid crystal component can switch a colored state in which light having at least some wavelengths is absorbed and a transparent state in which light is transmitted by switching a voltage applied state and a voltage non-applied state (Patent Literature 2).

### CITATION LIST

### Patent Literature

[PTL 1] JP 2002-189123 A
[PTL 2] WO 2022/186062 A1

### SUMMARY OF INVENTION

### Technical Problem

A related-art PDLC film using a dichroic dye tends to have low transparency in a colored state. Accordingly, in, for example, applications that require transparency and distinct visual legibility, there is a demand for a PDLC film having improved transparency in a colored state.

The present invention has been made to solve the above-mentioned problems, and a primary object of the present invention is to provide a PDLC film that can switch a colored state and a transparent state, and has improved transparency in the colored state.

### Solution to Problem

[1] According to one aspect of the present invention, there is provided a polymer dispersed liquid crystal film, including in the following order: a first transparent conductive film; a polymer dispersed liquid crystal layer; and a second transparent conductive film, wherein the polymer dispersed liquid crystal layer contains: a polymer matrix; and droplets dispersed in the polymer matrix, the droplets each containing a liquid crystal component and a dichroic dye, wherein the droplets have an average particle diameter of 1 μm or less, and wherein the polymer dispersed liquid crystal film has a clarity in a colored state of 90 or more.

[2] In the polymer dispersed liquid crystal film according to the above-mentioned item [1], the average particle diameter of the droplets may be 0.01 μm or more and less than 0.38 μm.

[3] In the polymer dispersed liquid crystal film according to the above-mentioned item [1] or [2], the liquid crystal component may have a birefringence of 0.25 or less.

[4] In the polymer dispersed liquid crystal film according to any one of the above-mentioned items [1] to [3], a weight ratio (former:latter) of a content of the polymer matrix to a total content of the liquid crystal component and the dichroic dye in the polymer dispersed liquid crystal layer may be from 10:90 to 70:30.

[5] In the polymer dispersed liquid crystal film according to any one of the above-mentioned items [1] to [4], the polymer dispersed liquid crystal layer may have a thickness of 30 μm or less.

[6] The polymer dispersed liquid crystal film according to any one of the above-mentioned items [1] to [5] may have a total light transmittance in a colored state of 50% or less.

[7] The polymer dispersed liquid crystal film according to any one of the above-mentioned items [1] to [6] may have a haze in a colored state of 80% or less.

### Advantageous Effects of Invention

According to the embodiment of the present invention, the PDLC film that can switch a colored state and a transparent state, and has improved transparency in the colored state is provided.

### BRIEF DESCRIPTION OF DRAWINGS

FIG. 1 is schematic cross-sectional views of a PDLC film in one embodiment of the present invention.

### DESCRIPTION OF EMBODIMENTS

Preferred embodiments of the present invention are described below. However, the present invention is not limited to these embodiments. In this description, the expression “from . . . to . . . ” representing a numerical range includes the upper limit and lower limit numerical values thereof.

### A. Polymer Dispersed Liquid Crystal Film

A polymer dispersed liquid crystal film according to an embodiment of the present invention includes in the following order: a first transparent conductive film; a polymer dispersed liquid crystal layer; and a second transparent conductive film. The polymer dispersed liquid crystal layer contains: a polymer matrix; and droplets (hereinafter sometimes referred to as “liquid crystal droplets”) dispersed in the polymer matrix, the droplets each containing a liquid crystal component and a dichroic dye. The droplets have an average particle diameter of 1 μm or less. The polymer dispersed liquid crystal film has a clarity in a colored state of 90 or more.

As described above, the appearance of the PDLC film changes in accordance with a voltage to be applied. In one embodiment, the PDLC film is in a transparent state at the time of application of a voltage, and is in a colored state at the time of application of no voltage (normal mode). In another embodiment, the PDLC film is in a colored state at the time of application of a voltage, and is in a transparent state at the time of application of no voltage (reverse mode).

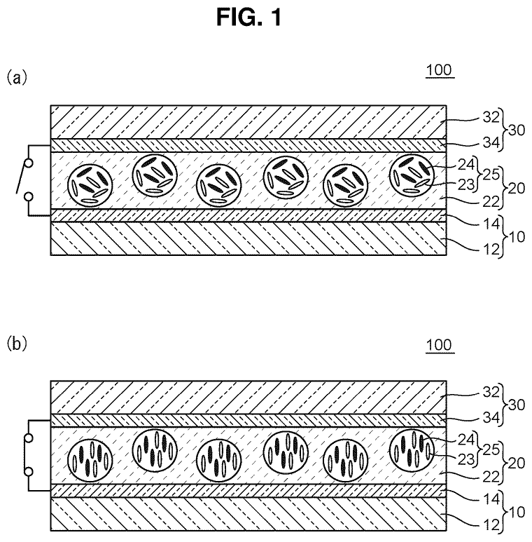

FIG. 1 is schematic cross-sectional views for illustrating the configuration of an example of a PDLC film of a normal mode according to the embodiment of the present invention. FIG. 1(a) is an illustration of a state in which no voltage is applied to the PDLC layer (a colored state), and FIG. 1(b) is an illustration of a state in which a voltage is applied to the PDLC layer (a transparent state). A PDLC film 100 includes a first transparent conductive film 10, a PDLC layer 20 containing a polymer matrix 22 and liquid crystal droplets 25 dispersed in the polymer matrix 22, and a second transparent conductive film 30 in the stated order. The liquid crystal droplets 25 are each a so-called quest-host liquid crystal containing a liquid crystal component 23 and a dichroic dye 24. At the time of application of no voltage, the liquid crystal component 23 and the dichroic dye 24 in the liquid crystal droplets 25 are not aligned as illustrated in FIG. 1(a), and the dichroic dye 24 absorbs light to bring the PDLC film 100 into a colored state. Meanwhile, at the time of application of a voltage, the liquid crystal component 23 is aligned in an electric field direction, and the dichroic dye 24 is also aligned following the liquid crystal component 23 as illustrated in FIG. 1(b). Thus, the refractive index of the liquid crystal droplets 25 and the refractive index of the polymer matrix 22 match with each other. As a result, the PDLC film 100 is brought into the transparent state.

Although not shown, according to the PDLC film of the reverse mode, an alignment film is arranged on the surface of a transparent conductive film, and thereby, the liquid crystal component 23 and the dichroic dye 24 in the liquid crystal droplets 25 are aligned at the time of application of no voltage to bring the PDLC film into the transparent state. When a voltage is applied, the alignment states of the liquid crystal component 23 and the dichroic dye 24 are changed. As a result, the PDLC film can be brought into the colored state.

The clarity of the PDLC film in the colored state is, for example, 90 or more, preferably 92 or more, more preferably 95 or more, still more preferably 97 or more. The upper limit of the clarity is 100. The clarity corresponds to the extent to which light is scattered at a small angle, and is a transmittance in an angle range of ±2.5° with respect to the advance direction of collimated light entering the PDLC film. A high clarity means that the boundary of an image viewed through the PDLC film is clear. The clarity is calculated from the following equation (1) where L_{C} represents the quantity of light that travels straight along the optical axis of collimated light entering the PDLC film and L_{R} represents the quantity of light scattered at a small angle within ±2.5° with respect to the optical axis of the collimated light, among the light transmitted through the PDLC film.

$$100 \times ( {L}_{C} - {L}_{R} ) / ( {L}_{C} + {L}_{R} ) \qquad Equation ( 1 )$$

The total light transmittance of the PDLC film in the colored state is, for example, 50% or less, may be 40% or less, 30% or less, 20% or less, or 10% or less, is, for example, 0.5% or more, and may be 1% or more. The total light transmittance of the PDLC film in the transparent state is, for example, 15% or more, may be 20% or more, 30% or more, or 50% or more, and is, for example, 99% or less. The difference in total light transmittance between the PDLC film in the transparent state and the PDLC film in the colored state is, for example, 10% or more, and may be 20% or more, or 30% or more. The total light transmittance may be measured in accordance with JIS K 7361.

The haze of the PDLC film in the colored state is, for example, 80% or less, may be 60% or less, 50% or less, or 45% or less, and is, for example, 5% or more. The haze of the PDLC film in the transparent state is, for example, 30% or less, may be 20% or less, 10% or less, or 5% or less, and is, for example, 0.1% or more. The difference in haze between the PDLC film in the transparent state and the PDLC film in the colored state is, for example, 10% or more, and may be 20% or more, 30% or more, or 40% or more. The haze may be measured in accordance with JIS K 7136.

A voltage applied to the PDLC film at the time of application of a voltage is a voltage (operating voltage) capable of operating the PDLC film, and may be, for example, from 5 V to 300 V, preferably from 10 V to 200 V. The phrase “at the time of application of a voltage” as used herein means a state in which an operating voltage is applied to a PDLC film, which may be, for example, a state in which a voltage of 150 V is applied.

The total thickness of the PDLC film is, for example, from 30 μm to 250 μm, preferably from 50 μm to 150 μm.

### A-1. First Transparent Conductive Film

The first transparent conductive film 10 typically includes a first transparent substrate 12 and a first transparent electrode layer 14 arranged on one side (PDLC layer 20 side) thereof. The first transparent conductive film 10 may include a hard coat layer on one side, or each of both sides, of the first transparent substrate 12 as required, and may include a refractive index-adjusting layer between the first transparent substrate 12 and the first transparent electrode layer 14.

The surface resistance value of the first transparent conductive film is preferably from 1Ω/□ to 1,000Ω/□, more preferably from 5Ω/□ to 300Ω/□, still more preferably from 10Ω/□ to 200 Ω/□.

The haze value of the first transparent conductive film is preferably 20% or less, more preferably 10% or less, still more preferably from 0.1% to 10%.

The total light transmittance of the first transparent conductive film is preferably 40% or more, more preferably 60% or more, still more preferably 80% or more.

The first transparent substrate may be formed by using any appropriate material. The first transparent substrate is typically a polymer film containing a thermoplastic resin as a main component. Examples of the thermoplastic resin include: a polyester-based resin; a cycloolefin-based resin such as polynorbornene; an acrylic resin; a polycarbonate-based resin; and a cellulose-based resin. Of those, a polyester-based resin, a cycloolefin-based resin, or an acrylic resin is preferred. Those resins are each excellent in transparency, mechanical strength, thermal stability, water barrier property, and the like. The thermoplastic resins may be used alone or in combination thereof. In addition, such an optical film as to be used in a polarizing plate, such as a low-retardation substrate, a high-retardation substrate, a retardation plate, an absorption-type polarizing film, or a polarization-selective reflective film, may be used as the first transparent substrate.

The thickness of the first transparent substrate is preferably 200 μm or less, more preferably from 3 μm to 100 μm, still more preferably from 5 μm to 70 μm. When the thickness of the first transparent substrate is set to 200 μm or less, the PDLC layer can be caused to sufficiently exhibit its function.

The total light transmittance of the first transparent substrate is preferably 40% or more, more preferably 60% or more, still more preferably 80% or more.

The first transparent electrode layer may be formed by using a metal oxide, such as an indium tin oxide (ITO), zinc oxide (ZnO), or tin oxide (SnO₂). In this case, the metal oxide may be an amorphous metal oxide or a crystallized metal oxide. The first transparent electrode layer may also be formed of a metal nanowire such as a silver nanowire (AgNW), a carbon nanotube (CNT), an organic conductive film, a metal layer, or a laminate thereof. A transparent electrode layer containing an ITO is preferably formed. The transparent electrode layer containing an ITO is excellent in transparency. The first transparent electrode layer may be patterned into a desired shape in accordance with purposes.

The total light transmittance of the first transparent electrode layer is preferably 85% or more, more preferably 87% or more, still more preferably 90% or more. When a transparent electrode layer having a total light transmittance within such ranges is used, a PDLC film having a high total light transmittance under a transparent state can be obtained. The total light transmittance of the first transparent electrode layer is preferably as high as possible, and its upper limit is, for example, 99%.

The thickness of the first transparent electrode layer is, for example, 10 nm or more, preferably 15 nm or more. The thickness of the first transparent electrode layer is, for example, 50 nm or less, preferably 35 nm or less, more preferably 30 nm or less.

The first transparent electrode layer is arranged on one surface of the first transparent substrate by, for example, sputtering. After the formation of a metal oxide layer by the sputtering, the layer can be crystallized by annealing. The annealing is performed by, for example, thermally treating the layer at from 120° C. to 300° C. for from 10 minutes to 120 minutes.

Description for detailed configurations of the refractive index-adjusting layer and the hard coat layer is omitted because configurations well-known in the art may be adopted for the refractive index-adjusting layer and the hard coat layer.

### A-2. Polymer Dispersed Liquid Crystal Layer

The PDLC layer 20 contains the polymer matrix 22 and the liquid crystal droplets 25 dispersed in the polymer matrix 22. The average particle diameter of the liquid crystal droplets is typically 1 μm or less, for example, 0.5 μm or less. The PDLC layer containing liquid crystal droplets each having a small particle diameter has a low scattering property. Accordingly, when the average particle diameter of the liquid crystal droplets is set to 1 μm or less, a PDLC film having a high clarity can be obtained. From the viewpoint of further reducing the scattering property, the average particle diameter of the liquid crystal droplets is preferably equal to or less than the wavelength of visible light. Specifically, the average particle diameter of the liquid crystal droplets is preferably less than 0.38 μm, more preferably less than 0.3 μm, still more preferably less than 0.2 μm, yet still more preferably 0.18 μm or less, yet still more preferably 0.15 μm or less, yet still more preferably 0.12 μm or less. The lower limit of the average particle diameter of the liquid crystal droplets is not limited as long as the effects of the present invention are obtained, and the average particle diameter may be, for example, 0.01 μm or more, or 0.05 μm or more. The average particle diameter of the liquid crystal droplets is a volume average particle diameter, and may be determined by, for example, a method described in Examples.

The particle diameters of the liquid crystal droplets preferably have a relatively narrow particle size distribution. The coefficient of variation (CV value) of the particle diameters of the liquid crystal droplets may be, for example, less than 0.4, and may be preferably 0.35 or less, more preferably 0.3 or less. The coefficient of variation may be calculated from the following equation.

CV value=standard deviation of particle diameter distribution of liquid crystal droplets/average particle diameter

The polymer matrix may include any appropriate resin. A resin for forming the polymer matrix may be appropriately selected in accordance with the light transmittance, the refractive index of the liquid crystal component, and the adhesive strength of the layer with the transparent conductive films. The resin for forming the polymer matrix preferably has a refractive index close to the refractive index of the liquid crystal component.

Specific examples of the resin for forming the polymer matrix include a urethane-based resin, a polyvinyl alcohol-based resin, a polyethylene-based resin, a polypropylene-based resin, and an acrylic resin. Those resins are each preferably a water-soluble resin or a water-dispersible resin. The resins for forming the polymer matrix may be used alone or in combination thereof.

Any appropriate liquid crystal compounds may be used alone or in combination thereof as the liquid crystal component. The birefringence at a wavelength of 589 nm of the liquid crystal component (Δn=ne−no; ne: extraordinary refractive index, no: ordinary refractive index) is, for example, 0.25 or less. The birefringence is preferably 0.2 or less, more preferably 0.15 or less, and may be, for example, 0.12 or less, or may be, for example, 0.1 or less, from the viewpoint of obtaining a PDLC film having a high clarity. The birefringence may be, for example, 0.01 or more, 0.05 or more, or 0.08 or more. When a liquid crystal component having the above-mentioned birefringence is used, the scattering property of the PDLC layer in the colored state (e.g., at the time of application of no voltage) can be reduced, and as a result, a PDLC film having a high clarity can be obtained.

The dielectric anisotropy of the liquid crystal component may be positive or negative. The liquid crystal component may be, for example, a nematic liquid crystal, a smectic liquid crystal, or a cholesteric liquid crystal. The nematic liquid crystal is preferably used because excellent transparency of the PDLC film in a transparent state can be achieved.

A nematic liquid crystal compound is, for example, a biphenyl-based compound, a phenyl benzoate-based compound, a cyclohexylbenzene-based compound, an azoxybenzene-based compound, an azobenzene-based compound, an azomethine-based compound, a terphenyl-based compound, a biphenyl benzoate-based compound, a cyclohexylbiphenyl-based compound, a phenylpyridine-based compound, a cyclohexylpyrimidine-based compound, a cholesterol-based compound, or a fluorine-based compound.

Any appropriate dichroic dye that is compatible with the liquid crystal component may be used as the dichroic dye. The dichroic dye may have a positive or negative Δε. The dichroic dye itself may exhibit liquid crystallinity. The dichroic dyes may be used alone or in combination thereof.

Specific examples of the dichroic dye include an azo-based dye, an anthraquinone-based dye, a naphthoquinone-based dye, a perylene-based dye, a quinophthalone-based dye, a tetrazine-based dye, and a benzothiadiazole-based dye. Of those, an anthraquinone-based dye or an azo-based dye is preferably incorporated as the dichroic dye from the viewpoints of, for example, an extinction coefficient, a degree of solubility in the liquid crystal component, and light resistance. For example, an azo-based dye, an anthraquinone-based dye, or a mixture thereof, described in “Liquid Crystal Device Handbook,” edited by Committee No. 142 of the Japan Society for the Promotion of Science, Nihon Kogyo Shimbun (1989), pp. 192-196 and pp. 724-730, may be used. In addition, various dichroic dyes are commercially available, and may be appropriately used.

The PDLC layer may further contain any appropriate component as required. Examples of such component include a surfactant, a leveling agent, a cross-linking agent, and a dispersion stabilizer.

The content ratio of the liquid crystal component in the PDLC layer is, for example, from 30 wt % to 90 wt %, preferably from 35 wt % to 85 wt %, more preferably from 40 wt % to 80 wt %.

The content of the dichroic dye in the PDLC layer is, for example, from 0.1 part by weight to 20 parts by weight, preferably from 1 part by weight to 15 parts by weight, more preferably from 3 parts by weight to 10 parts by weight, with respect to 100 parts by weight of the liquid crystal component.

The weight ratio (former:latter) of the content of the polymer matrix to the total content of the liquid crystal component and the dichroic dye in the PDLC layer is, for example, from 10:90 to 70:30, preferably from 15:85 to 65:35, more preferably from 20:80 to 60:40.

The total content ratio of the polymer matrix, the liquid crystal component, and the dichroic dye in the PDLC layer is, for example, 80 wt % or more, preferably 90 wt % or more, more preferably 95 wt % or more, and is, for example, 100 wt % or less, preferably 99 wt % or less.

The thickness of the PDLC layer is preferably 40 μm or less, more preferably 30 μm or less, and may be, for example, 25 μm or less, or may be, for example, 20 μm or less, and the thickness is preferably 2 μm or more, more preferably 3 μm or more, and may be, for example, 5 μm or more, or may be, for example, 10 μm or more. When the thickness of the PDLC layer falls within the ranges, a PDLC film having a high clarity and high colorability can be suitably obtained.

### A-3. Second Transparent Conductive Film

The second transparent conductive film 30 typically includes a second transparent substrate 32 and a second transparent electrode layer 34 arranged on one side (PDLC layer 20 side) thereof. The second transparent conductive film 30 may include a hard coat layer on one side, or each of both sides, of the second transparent substrate 32 as required, and may include a refractive index-adjusting layer between the second transparent substrate 32 and the second transparent electrode layer 34.

The surface resistance value of the second transparent conductive film is preferably from 1Ω/□ to 1,000Ω/□, more preferably from 5Ω/□ to 300Ω/□, still more preferably from 10Ω/□ to 200 Ω/□.

The haze value of the second transparent conductive film is preferably 20% or less, more preferably 10% or less, still more preferably from 0.1% to 10%.

The total light transmittance of the second transparent conductive film is preferably 40% or more, more preferably 60% or more, still more preferably 80% or more.

The same descriptions as those of the first transparent substrate and the first transparent electrode layer may be applied to the second transparent substrate and the second transparent electrode layer, respectively. The second transparent conductive film may have the same configuration as that of the first transparent conductive film, or may have a configuration different therefrom.

B. Method of producing Polymer Dispersed Liquid Crystal Film

The PDLC film described in the section A may be produced by any appropriate production method. The method of producing the PDLC film described in the section A includes, for example:
mixing a liquid crystal component, a dichroic dye, and a dispersion medium to prepare a liquid crystal emulsion containing particles each containing the liquid crystal component and the dichroic dye (step A);
mixing the liquid crystal emulsion and a resin for forming a polymer matrix to prepare an application liquid containing the particles (step B);
applying the application liquid to a first transparent conductive film to provide an applied layer (step C);
drying the applied layer to provide a PDLC layer containing a polymer matrix, and droplets dispersed in the polymer matrix, the droplets each containing the liquid crystal component and the dichroic dye (step D); and
laminating a second transparent conductive film on the PDLC layer (step E).

### B-1. Step A

In the step A, a liquid crystal component, a dichroic dye, and a dispersion medium are mixed to prepare a liquid crystal emulsion containing particles (hereinafter sometimes referred to as “liquid crystal particles”) each containing the liquid crystal component and the dichroic dye.

Water or a mixed solvent of water and a water-miscible organic solvent may be preferably used as the dispersion medium. Examples of the water-miscible organic solvent include a C1-3 alcohol, acetone, and DMSO. The liquid crystal component and the dichroic dye are as described in the section A.

The content ratio of the liquid crystal component in the liquid crystal emulsion is, for example, from 30 wt % to 70 wt %, preferably from 40 wt % to 60 wt %.

The content of the dichroic dye in the liquid crystal emulsion is, for example, from 0.1 part by weight to 20 parts by weight, preferably from 1 part by weight to 15 parts by weight, more preferably from 3 parts by weight to 10 parts by weight, with respect to 100 parts by weight of the liquid crystal component.

The average particle diameter of the liquid crystal particles is typically 1 μm or less, for example, 0.5 μm or less, preferably less than 0.38 μm, more preferably less than 0.3 μm, still more preferably less than 0.2 μm, yet still more preferably 0.18 μm or less, yet still more preferably 0.15 μm or less, yet still more preferably 0.12 μm or less, and may be, for example, 0.01 μm or more, or 0.05 μm or more. The particle diameters of the liquid crystal droplets in the PDLC layer may depend on the particle diameters of the liquid crystal particles in the liquid crystal emulsion. Accordingly, when the average particle diameter of the liquid crystal particles in the liquid crystal emulsion falls within the ranges, the average particle diameter of the liquid crystal droplets in the PDLC layer can be set within a desired range. The average particle diameter of the liquid crystal particles means a median diameter on a volume basis, and may be measured with a dynamic light scattering-type particle size distribution measuring apparatus.

The particle diameters of the liquid crystal particles preferably have a relatively narrow particle size distribution. The coefficient of variation (CV value) of the particle diameters of the liquid crystal particles may be, for example, less than 0.4, and may be preferably 0.35 or less, more preferably 0.3 or less.

The liquid crystal emulsion may be prepared by, for example, a mechanical emulsification method, a microchannel method, or a membrane emulsification method. The liquid crystal emulsion is preferably prepared by the mechanical emulsification method or the membrane emulsification method. According to the mechanical emulsification method, a liquid crystal emulsion containing particles each having a small particle diameter may be efficiently obtained. The mechanical emulsification method may be performed with a known dispersive mixing apparatus, such as a homomixer or a homogenizer, preferably with a homogenizer, such as a high-pressure homogenizer or an ultrasonic homogenizer. According to the membrane emulsification method, an emulsion having a uniform particle size distribution may be suitably obtained. Reference may be made to the disclosures of, for example, JP 04-355719 A and JP 2015-40994 A (these literatures are incorporated herein by reference) for details about the membrane emulsification method.

The order of mixing the liquid crystal component, the dichroic dye, and the dispersion medium is not particularly limited. For example, the liquid crystal component and the dichroic dye may be mixed and the resultant mixture and the dispersion medium may be mixed, or the three components may be added and mixed simultaneously.

### B-2. Step B

In the step B, the liquid crystal emulsion obtained in the step A and a resin for forming a polymer matrix are mixed to prepare an application liquid containing the liquid crystal particles. The application liquid may contain another optional component as required. Examples of the optional component include a surfactant, a leveling agent, a cross-linking agent, and a dispersion stabilizer. The optional component may be added to the liquid crystal emulsion in the step A in accordance with purposes.

The resin for forming a polymer matrix is as described in the section A. The resin for forming a polymer matrix is mixed with the liquid crystal emulsion, for example, as a resin dispersion in which resin particles for forming a polymer matrix are dispersed in a dispersion medium or a resin solution in which the resin for forming a polymer matrix is dissolved in a solvent. In this case, the same substance as the dispersion medium used in the preparation of the liquid crystal emulsion may be used as the dispersion medium of the resin dispersion or the solvent of the resin solution.

The average particle diameter of the resin particles for forming a polymer matrix is preferably from 10 nm to 500 nm, more preferably from 30 nm to 300 nm, still more preferably from 50 nm to 200 nm. Two or more kinds of resin particles that differ in kind of a resin and/or average particle diameter may be used. The average particle diameter of the resin particles for forming a polymer matrix means a median diameter on a volume basis, and may be measured with a dynamic light scattering-type particle size distribution measuring apparatus.

The particle diameters of the liquid crystal particles in the application liquid are substantially the same as the particle diameters in the liquid crystal emulsion. Accordingly, the average particle diameter (volume average particle diameter) of the liquid crystal particles in the application liquid is typically 1 μm or less, for example, 0.5 μm or less, preferably less than 0.38 μm, more preferably less than 0.3 μm, still more preferably less than 0.2 μm, yet still more preferably 0.18 μm or less, yet still more preferably 0.15 μm or less, yet still more preferably 0.12 μm or less, and may be, for example, 0.01 μm or more, or 0.05 μm or more.

The content ratio of the liquid crystal component in the solid content of the application liquid is, for example, from 30 wt % to 90 wt %, preferably from 35 wt % to 85 wt %, more preferably from 40 wt % to 80 wt %.

The weight ratio (former:latter) of the content of the resin for forming a polymer matrix to the total content of the liquid crystal component and the dichroic dye in the application liquid is, for example, from 10:90 to 70:30, preferably from 15:85 to 65:35, more preferably from 20:80 to 60:40.

The total content ratio of the resin for forming a polymer matrix, the liquid crystal component, and the dichroic dye in the solid content of the application liquid is, for example, 80 wt % or more, preferably 90 wt % or more, more preferably 95 wt % or more, and is, for example, 100 wt % or less, preferably 99 wt % or less.

Examples of the surfactant may include an anionic surfactant, a cationic surfactant, an amphoteric surfactant, and a nonionic surfactant. The content ratio of the surfactant is preferably from 1 part by weight to 15 parts by weight, more preferably from 2 parts by weight to 10 parts by weight, with respect to 100 parts by weight of the solid content of the application liquid.

Examples of the leveling agent may include an acrylic leveling agent, a fluorine-based leveling agent, and a silicone-based leveling agent. The content of the leveling agent is preferably from 0.1 part by weight to 10 parts by weight, more preferably from 0.5 part by weight to 5 parts by weight, with respect to 100 parts by weight of the solid content of the application liquid.

Examples of the cross-linking agent may include an aziridine-based cross-linking agent and an isocyanate-based cross-linking agent. The content of the cross-linking agent is preferably from 0.5 part by weight to 20 parts by weight, more preferably from 1 part by weight to 10 parts by weight, with respect to 100 parts by weight of the solid content of the application liquid.

The solid content concentration of the application liquid may be, for example, from 20 wt % to 60 wt %, preferably from 30 wt % to 50 wt %.

### B-3. Step C

In the step C, the application liquid prepared in the section B is applied to a first transparent conductive film to provide an applied layer.

The application liquid is typically applied to the surface of the first transparent conductive film on the transparent electrode layer side. The first transparent conductive film is as described in the section A.

The viscosity of the application liquid at the time of the application is preferably from 20 mPa·s to 400 mPa·s, more preferably from 30 mPa·s to 300 mPa·s, still more preferably from 40 mPa·s to 200 mPa·s. When the viscosity is less than 20 mPa·s, the convection of the dispersion medium may become remarkable at the time of the drying of the dispersion medium to destabilize the thickness of the PDLC layer. In addition, when the viscosity is more than 400 mPa·s, the beads of the application liquid may not be stable. The viscosity of the application liquid may be measured with, for example, a rheometer MCR302 manufactured by Anton Paar GmbH. The value of a shear viscosity under the conditions of 20° C. and a shear rate of 1,000 (1/s) is used as the viscosity herein.

Any appropriate method may be adopted as an application method. Examples thereof include a roll coating method, a spin coating method, a bar coating method, a dip coating method, a die coating method, a curtain coating method, a spray coating method, and a knife coating method (e.g., a comma coating method). Of those, a roll coating method is preferred. For example, reference may be made to the description of JP 2019-5698 A for the application by the roll coating method with a slot die.

The thickness of the applied layer is preferably from 1 μm to 100 μm, more preferably from 2 μm to 90 μm, still more preferably from 5 μm to 75 μm.

### B-4. Step D

In the step D, the applied layer is dried to provide a PDLC layer containing a polymer matrix, and droplets dispersed in the polymer matrix, the droplets each containing the liquid crystal component and the dichroic dye. The dispersion medium is removed from the applied layer by the drying, and the resin for forming a polymer matrix and particles each containing the liquid crystal component remain. As a result, a PDLC layer having a structure in which the liquid crystal droplets are dispersed in the polymer matrix is formed.

The drying of the applied layer may be performed by any appropriate method. Specific examples of the drying method include natural drying, heat drying, and hot-air drying. When the application liquid contains a cross-linking agent, the cross-linked structure of the polymer matrix may be formed at the time of the drying.

A drying temperature is preferably from 20° C. to 150° C., more preferably from 25° C. to 80° C. A drying time is preferably from 1 minute to 100 minutes, more preferably from 2 minutes to 10 minutes.

### B-5. Step E

In the step E, a second transparent conductive film is laminated on the PDLC layer. Thus, a PDLC film including the first transparent conductive film, the PDLC layer, and the second transparent conductive film in the stated order is obtained.

The second transparent conductive film is as described in the section A. The lamination of the second transparent conductive film on the PDLC layer is typically performed so that the second transparent electrode layer side of the film may face the PDLC layer. From the viewpoint of obtaining sufficient adhesiveness, the lamination may be preferably performed while a lamination pressure of from 0.006 MPa/m to 7 MPa/m, more preferably a lamination pressure of from 0.06 MPa/m to 0.7 MPa/m is applied with a laminator.

### EXAMPLES

The present invention is specifically described below by way of Examples. However, the present invention is by no means limited to these Examples. Measurement methods for characteristics are as described below. In addition, “part(s)” and “%” in Examples and Comparative Examples are by weight unless otherwise stated.

### (1) Thickness

Measurement was performed with a digital micrometer (manufactured by Anritsu Corporation, product name: “KC-351C”).

### (2) Volume Average Particle Diameter of Liquid Crystal Particles in Liquid Crystal Emulsion

Several droplets of a liquid crystal emulsion were added to 100 ml of water to prepare a measurement sample. The measurement sample was set in the measurement holder of a dynamic light scattering-type particle diameter distribution-measuring apparatus (manufactured by Microtrac Retsch GmbH, apparatus name: “Nanotrac 150”), and the fact that the concentration of liquid crystal particles was measurable was recognized with the monitor of the apparatus, followed by the measurement of the average particle diameter of the liquid crystal particles with the apparatus.

### (3) Average Particle Diameter of Resin Particles

Several droplets of a resin dispersion were added to 100 mL of water to prepare a measurement sample. The measurement sample was set in the measurement holder of a dynamic light scattering-type particle diameter distribution-measuring apparatus (manufactured by Microtrac Retsch GmbH, apparatus name: “Nanotrac 150”), and the fact that the concentration of resin particles was measurable was recognized with the monitor of the apparatus, followed by the measurement of the average particle diameter of the resin particles with the apparatus.

### (4) Haze

Measurement was performed with a haze meter (manufactured by Nippon Denshoku Industries Co., Ltd., product name: “NDH4000”) in accordance with JIS K 7136.

### (5) Total Light Transmittance

Measurement was performed with a haze meter (manufactured by Nippon Denshoku Industries Co., Ltd., product name: “NDH4000”) in accordance with JIS K 7361.

### (6) Clarity

Measurement was performed with a haze meter (manufactured by BYK-Gardner GmbH, product name: “haze-gard i”) in accordance with a method specified by the manufacturer.

### (7) Average Particle Diameter of Liquid Crystal Droplets in PDLC Layer

A PDLC film was sliced in a horizontal direction under a cooling environment, and the exposed horizontal section of the PDLC layer was smoothed with a microtome. Next, the horizontal section of the PDLC layer was observed with a scanning electron microscope (SEM), and a cross-sectional SEM image was obtained. An area-equivalent circle diameter (Heywood diameter) was calculated from the cross-sectional area of each of all the liquid crystal droplets in a region of 30 μm×20 μm in the sectional SEM image, statistics weighted by volumes estimated for the respective area-equivalent circle diameters were collected, and a volume average particle diameter (median diameter) was calculated.

### (8) Birefringence of Liquid Crystal Component

A value disclosed by the manufacturer for a liquid crystal component was used.

### Example 1

### (First and Second Transparent Conductive Films)

An ITO layer was formed on one surface of a PET substrate (thickness: 50 μm) by a sputtering method to provide a transparent conductive film having the configuration [transparent substrate/transparent electrode layer].

### (Preparation of Liquid Crystal Emulsion)

27.9 Parts of a liquid crystal component containing two or more kinds of liquid crystal compounds (manufactured by JNC Corporation, product name: “JC-5175XX”, birefringence Δn=0.09 (ne=1.569, no=1.479, dielectric anisotropy Δε=7.9, viscosity=32.2 mPa·s), 0.26 part of a dichroic dye (manufactured by Hayashibara Co., Ltd., product name: “G-470”), 0.53 part of a dichroic dye (manufactured by Hayashibara Co., Ltd., product name: “NKX-3739”), 1.31 parts of a dichroic dye (manufactured by Hayashibara Co., Ltd., product name: “NKX-3708”), 67 parts of pure water, and 3 parts of a surfactant (manufactured by DKS Co. Ltd., “NOIGEN ET159”) were mixed, and the mixture was treated with a high-pressure homogenizer to prepare a liquid crystal emulsion. The average particle diameter of liquid crystal particles in the resultant liquid crystal emulsion was 170 nm.

### (Preparation of Application Liquid)

47.6 Parts of the above-mentioned liquid crystal emulsion, 32 parts of a polyether-based polyurethane resin aqueous dispersion (manufactured by DSM, product name: “NeoRez R967”, polymer average particle diameter: 80 nm, CV value=0.27, solid content: 40 wt %), 0.1 part of a leveling agent (manufactured by DIC Corporation, product name: “F-444”), 1 part of a cross-linking agent (propylidynetrimethyl tris [3-(2-methylaziridin-1-yl)propionate]), and 19.3 parts of pure water were mixed to provide an emulsion application liquid (solid content concentration: 30 wt %).

### (Production of PDLC Film)

The above-mentioned emulsion application liquid was applied to the ITO layer surface of the first transparent conductive film, and dried at 40° C. to form a PDLC layer having a thickness of 16 μm. After that, while a lamination pressure of 0.4 MPa/m was applied with a laminator, the second transparent conductive film was laminated on the above-mentioned PDLC layer so that its ITO layer faced the PDLC layer. Thus, a PDLC film was obtained.

### Examples 2 to 8

Each PDLC film was obtained in the same manner as in Example 1 except that a different kind of liquid crystal component was used, a liquid crystal emulsion containing liquid crystal particles having a different average particle diameter was prepared, and/or the thickness of the PDLC layer was changed, as shown in Table 1. The properties of the used liquid crystal components are as described below.
Liquid crystal component (manufactured by JNC Corporation, product name: “JC-5174XX”, birefringence Δn=0.098 (ne=1.577, no=1.479), dielectric anisotropy Δε=11.8, viscosity=46.8 mPa·s)
Liquid crystal component (manufactured by JNC Corporation, product name: “JC-5173XX”, birefringence Δn=0.149 (ne=1.651, no=1.502), dielectric anisotropy Δg=10.0, viscosity=48.5 mPa·s)

### Comparative Example 1

### (First and Second Transparent Conductive Films)

An ITO layer was formed on one surface of a PET substrate (thickness: 50 μm) by a sputtering method to provide a transparent conductive film having the configuration [transparent substrate/transparent electrode layer].

### (Production of Liquid Crystal Emulsion)

27.9 Parts of a liquid crystal component (manufactured by JNC Corporation, product name: “JC-5174XX”), 0.26 part of a dichroic dye (manufactured by Hayashibara Co., Ltd., product name: “G-470”), 0.53 part of a dichroic dye (manufactured by Hayashibara Co., Ltd., product name: “NKX-3739”), 1.31 parts of a dichroic dye (manufactured by Hayashibara Co., Ltd., product name: “NKX-3708”), 67 parts of pure water, and 3 parts of a surfactant (manufactured by DKS Co. Ltd., “NOIGEN ET159”) were mixed, and the mixture was stirred at 100 rpm for 10 minutes with a homogenizer to be coarsely dispersed. The coarse dispersion was allowed to permeate through a separation membrane having a uniform particle size distribution (manufactured by SPG Technology Co., Ltd., “SPG pumping connector”, pore diameter: 5 μm) at a flow rate of 80 mL/min/cm² so as to pass through the membrane from the outside to the inside at room temperature. This operation was performed 10 times. The volume average particle diameter of liquid crystal particles in the resultant liquid crystal emulsion was 2.1 μm.

### (Preparation of Application Liquid)

47.6 Parts of the above-mentioned liquid crystal emulsion, 2 parts of a polyether-based polyurethane resin aqueous dispersion (manufactured by DSM, product name: “NeoRez R967”, polymer average particle diameter: 80 nm, CV value=0.27, solid content: 40 wt %), 0.1 part of a leveling agent (manufactured by DIC Corporation, product name: “F-444”), 1 part of a cross-linking agent (propylidynetrimethyl tris [3-(2-methylaziridin-1-yl)propionate]), and 19.3 parts of pure water were mixed to provide an emulsion application liquid (solid content concentration: 30 wt %).

### (Production of PDLC Film)

The above-mentioned emulsion application liquid was applied to the ITO layer surface of the first transparent conductive film, and dried at 40° C. to form a PDLC layer having a thickness of 16 μm. After that, while a lamination pressure of 0.4 MPa/m was applied with a laminator, the second transparent conductive film was laminated on the above-mentioned PDLC layer so that its ITO layer faced the PDLC layer. Thus, a PDLC film was obtained.

### Comparative Example 2

A PDLC film was obtained in the same manner as in Comparative Example 1 except that a different kind of liquid crystal component was used as shown in Table 1.

### <Evaluation of Visual Transparency>

Visual transparency was evaluated in accordance with the following criteria based on the visibility of characters when a sheet of plain paper on which the characters were printed with black ink was visually observed through the PDLC film obtained in each of Examples and Comparative Examples (in a colored state under application of no voltage). The distance between the plain paper and the PDLC film was about 200 mm, and the distance between an observer's eye and the plain paper was 200 mm. The evaluation results are shown in Table 1 with the clarity, total light transmittance, and haze of each of the PDLC films.

### <<Evaluation Criteria>>

Excellent: The transparency is extremely high, and the characters can be clearly recognized.
Satisfactory: The transparency is slightly high, and the characters can be recognized.
Unsatisfactory: The transparency is low, and the characters cannot be recognized.

TABLE 1

| | | Example | | | | |
|---|---|---|---|---|---|---|
| | | 1 | 2 | 3 | 4 | 5 |
| Thickness (μm) of | | 16 | 16 | 16 | 16 | 16 |
| PDLC layer | | | | | | |
| Liquid | Kind | JC-5175XX | JC-5174XX | JC-5174XX | JC-5174XX | JC-5173XX |
| crystal | Δn | 0.09 | 0.098 | 0.098 | 0.098 | 0.149 |
| material | | | | | | |
| Average particle | | 170 | 100 | 170 | 320 | 100 |
| diameter (nm) of | | | | | | |
| liquid crystal | | | | | | |
| particles | | | | | | |
| Average particle | | 180 | 130 | 260 | 350 | 130 |
| diameter (nm) of | | | | | | |
| liquid crystal | | | | | | |
| droplets | | | | | | |
| Total light | ON | 37.5 | 36.5 | 34.7 | 33.8 | 41.3 |
| transmittance (%) | OFF | 5.0 | 4.6 | 4.4 | 6.2 | 6.5 |
| Haze (%) | ON | 1.6 | 1.7 | 1.8 | 3.2 | 1.1 |
| | OFF | 39.6 | 15.2 | 38.7 | 60.7 | 15.5 |
| Clarity | OFF | 97.9 | 98.5 | 97.7 | 92.2 | 99.3 |

| | | | | | |
|---|---|---|---|---|---|
| Visual transparency | Excellent | Excellent | Excellent | Satisfactory | Excellent |

| | | Example | | | Comparative Example | |
|---|---|---|---|---|---|---|
| | | 6 | 7 | 8 | 1 | 2 |
| Thickness (μm) of | | 16 | 16 | 20 | 16 | 16 |
| PDLC layer | | | | | | |
| Liquid | Kind | JC-5173XX | JC-5173XX | JC-5174XX | JC-5174XX | JC-5173XX |
| crystal | Δn | 0.149 | 0.149 | 0.098 | 0.098 | 0.149 |
| material | | | | | | |
| Average particle | | 170 | 320 | 100 | 2,100 | 2,100 |
| diameter (nm) of | | | | | | |
| liquid crystal | | | | | | |
| particles | | | | | | |
| Average particle | | 180 | 350 | 130 | 1,700 | 1,700 |
| diameter (nm) of | | | | | | |
| liquid crystal | | | | | | |
| droplets | | | | | | |
| Total light | ON | 37.9 | 47.5 | 32.3 | 29.9 | 44.2 |
| transmittance (%) | OFF | 6.42 | 8.41 | 1.0 | 2.21 | 2.43 |
| Haze (%) | ON | 4.1 | 7.5 | 1.2 | 4.9 | 7.8 |
| | OFF | 58.8 | 79.7 | 35.1 | 93.8 | 98.6 |
| Clarity | OFF | 97.4 | 92.4 | 97.1 | 67.2 | 18.1 |

| | | | | | |
|---|---|---|---|---|---|
| Visual transparency | Excellent | Satisfactory | Excellent | Unsatisfactory | Unsatisfactory |

“ON” means a state in which a voltage of 150 V was applied to the PDLC film, and “OFF” means a state in which no voltage was applied.

As shown in Table 1, the PDLC films of Examples each exhibited a low scattering property and a high clarity in the colored state.

### INDUSTRIAL APPLICABILITY

The PDLC film of the present invention is suitably used in various applications including display bodies, such as an advertisement and a guide plate, and a smart window.

### REFERENCE SIGNS LIST

100 PDLC film
10 first transparent conductive film
20 PDLC layer
22 polymer matrix
23 liquid crystal component
24 dichroic dye
25 liquid crystal droplet
30 second transparent conductive film

1. A polymer dispersed liquid crystal film, comprising in the following order:
a first transparent conductive film;
a polymer dispersed liquid crystal layer; and
a second transparent conductive film,
wherein the polymer dispersed liquid crystal layer contains: a polymer matrix; and droplets dispersed in the polymer matrix, the droplets each containing a liquid crystal component and a dichroic dye,
wherein the droplets have an average particle diameter of 1 μm or less,
wherein the polymer dispersed liquid crystal film has a haze in a colored state of 15.2% or more,
wherein the polymer dispersed liquid crystal film has a clarity in a colored state of 90 or more, and
wherein the clarity is calculated from the following equation (1) where L_{C} represents a quantity of light that travels straight along an optical axis of collimated light entering the polymer dispersed liquid crystal film and L_{R} represents a quantity of light scattered at a small angle within ±2.5° with respect to the optical axis of the collimated light, among light transmitted through the polymer dispersed liquid crystal film,
100×(L_{C}−L_{R})/(L_{C}+L_{R}) Equation (1).

2. The polymer dispersed liquid crystal film according to claim 1, wherein the average particle diameter of the droplets is 0.01 μm or more and less than 0.38 μm.

3. The polymer dispersed liquid crystal film according to claim 1, wherein the liquid crystal component has a birefringence of 0.25 or less.

4. The polymer dispersed liquid crystal film according to claim 1, wherein a weight ratio (former:latter) of a content of the polymer matrix to a total content of the liquid crystal component and the dichroic dye in the polymer dispersed liquid crystal layer is from 10:90 to 70:30.

5. The polymer dispersed liquid crystal film according to claim 1, wherein the polymer dispersed liquid crystal layer has a thickness of 30 μm or less.

6. The polymer dispersed liquid crystal film according to claim 1, wherein the polymer dispersed liquid crystal film has a total light transmittance in a colored state of 50% or less.

7. The polymer dispersed liquid crystal film according to claim 1, wherein the polymer dispersed liquid crystal film has a haze in a colored state of 80% or less.
